(19) United States
(12) Patent Application Publication
(10) Pub. No.: US 2025/0246034 A1
(43) Pub. Date: Jul. 31, 2025

(54) UNIDIRECTIONAL WIRELESS COMMUNICATION HUB

(71) Applicant: Ford Global Technologies, LLC, Dearborn, MI (US)

(72) Inventors: Russell Andres, Riverview, MI (US); Chitra Varanasi, Canton, MI (US); David Kaiser, Allen Park, MI (US); Marshall Earnest, Seattle, WA (US); Bradley G. Hochrein, Dexter, MI (US)

(21) Appl. No.: 18/428,281

(22) Filed: Jan. 31, 2024

(51) Int. Cl. G07C 9/00; H04W 72/30

(52) U.S. Cl. CPC G07C 9/00309; H04W 72/30

(57) ABSTRACT

A vehicle operates as a hub for communication with portable devices. The vehicle receives a plurality of packets of a cyclic series of state information sent over a local network broadcast from a portable device. The local network broadcast is sent over a connectionless broadcast protocol, where each of the plurality of packets includes a device identifier of the portable device, a field identifier of the state information being sent, and a data element indicative of a value of the state information for the field identifier. An information cache is updated to include the state information. A request is received for the state information from a mobile device over a data connection, the request including the device identifier. The requested state information is sent to the mobile device as retrieved from the information cache according to the device identifier.

### TECHNICAL FIELD

Aspects of the disclosure generally relate to a hub for managing unidirectional wireless communications.

### BACKGROUND

Phone-as-a-key (PaaK) systems are being introduced to allow users to utilize their phones to unlock a vehicle without requiring a key fob device. These systems may operate similar to a key fob, but where the phone communicates with the vehicle over BLUETOOTH LOW ENERGY (BLE), Ultra-Wide Band (UWB), or other mobile device wireless technologies.

Portable water filters may be used by backpackers or hikers to ensure a supply of clean water. The water filters may use various techniques, such as filter membranes, chlorine or iodine tablets, or other filter media.

### SUMMARY

In one or more illustrative examples, a method of using a vehicle as hub for communication with portable devices is provided. The vehicle receives a plurality of packets of a cyclic series of state information sent over a local network broadcast from a portable device. The local network broadcast is sent over a connectionless broadcast protocol, where each of the plurality of packets includes a device identifier of the portable device, a field identifier of the state information being sent, and a data element indicative of a value of the state information for the field identifier. An information cache is updated to include the state information. A request is received for the state information from a mobile device over a data connection, the request including the device identifier. The requested state information is sent to the mobile device as retrieved from the information cache according to the device identifier.

In one or more illustrative examples, a system implementing a hub for communication with portable devices is provided. One or more computing devices are configured to receive a plurality of packets of a cyclic series of state information sent over a local network broadcast from a portable device, the local network broadcast being sent over a connectionless broadcast protocol, each of the plurality of packets including a device identifier of the portable device, a field identifier of the state information being sent, and a data element indicative of a value of the state information for the field identifier; update an information cache to include the state information; receive a request for the state information from a mobile device over a data connection, the request including the device identifier; and send the requested state information to the mobile device as retrieved from the information cache according to the device identifier.

In one or more illustrative examples, a non-transitory computer-readable medium includes instructions for implementing a hub for communication with portable devices that, when executed by one or more computing devices, cause the one or more computing devices to perform operations including to receive a plurality of packets of a cyclic series of state information sent over a local network broadcast from a portable device, the local network broadcast being sent over a connectionless broadcast protocol, each of the plurality of packets including a device identifier of the portable device, a field identifier of the state information being sent, and a data element indicative of a value of the state information for the field identifier; update an information cache to include the state information; receive a request for the state information from a mobile device over a data connection, the request including the device identifier; and send the requested state information to the mobile device as retrieved from the information cache according to the device identifier.

### BRIEF DESCRIPTION OF THE DRAWINGS

FIG. 1 illustrates an example system for using a vehicle as a hub implementing a unidirectional wireless communication protocol;

FIG. 2 illustrates an example arrangement of the mobile device receiving the local network broadcasts from the portable device;

FIG. 3 illustrates an example arrangement of the vehicle receiving the local network broadcasts from the portable device;

FIG. 4 illustrates an example diagram of a cyclic series of local network broadcasts;

FIG. 5 illustrates an example of an information cache, in accordance with an example use case;

FIG. 6 illustrates an example diagram of the vehicle operating as a hub responding to requests;

FIG. 7 illustrates an example diagram of the vehicle operating as a hub responding to received commands;

FIG. 8 illustrates an example process for the use of the vehicle as a hub implementing a unidirectional wireless communication protocol maintaining the information cache;

FIG. 9 illustrates an example process for controlling the portable device from the vehicle operating as a hub; and

FIG. 10 illustrates an example of a computing device for use in using the vehicle as a hub for communications with portable devices.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Many applications require wireless communication with either a smartphone app or with a connected vehicle. Yet there exist few methods of doing so that are broadly available, if compatibility with existing devices is desired. Wi-Fi is impractical away from an access point, and smartphones prioritize Wi-Fi networks for Internet access, so creating an access point for communication would block the phone from using cellular data. Traditional Bluetooth requires pairing, which can cause unwanted setup hurdles and have device count limitations. UWB is not present on many devices that may desire to connect. Cellular access is power-hungry, impractical for low data rates, and relatively expensive. Acoustic communication is very short range.

As a further obstacle, some applications do not support other local communication methods due to permissions or design guidelines, and may be limited to Internet access only. For these, an aggregator-type device may be useful, such as a connected vehicle, if the application is to be used with multiple devices and/or with the vehicle.

Aspects of the disclosure relate to a unidirectional wireless communication protocol implemented by portable devices and vehicle hubs for use with connected applications. The portable devices may include various state information that may be useful to the connected applications. In the protocol, communication is established via a cyclic series of connectionless advertising packets, which can be received by various radios, without requiring pairing with that radio. In one approach, these packets may be received to a mobile device executing the connected application. In another approach, these packets may be received to a vehicle acting as a hub, where the vehicle collected and manages lifecycle of the state information received in the packets, and the mobile device accesses the vehicle to capture the most current data in the advertising packets.

The protocol may be used for communication with portable water filter devices. The filter devices may broadcast information such as whether the filter is in operation, ambient temperature, filter media status, etc. However, it should be noted that this is only one example, and other use cases for the hub, stateful portable devices, and unidirectional wireless communication protocol approach may be used. As another example, the portable device may be an air compressor, where the air compressor may broadcast information such as air pressure of the air compressor or pressure of a tire connected to the air compressor.

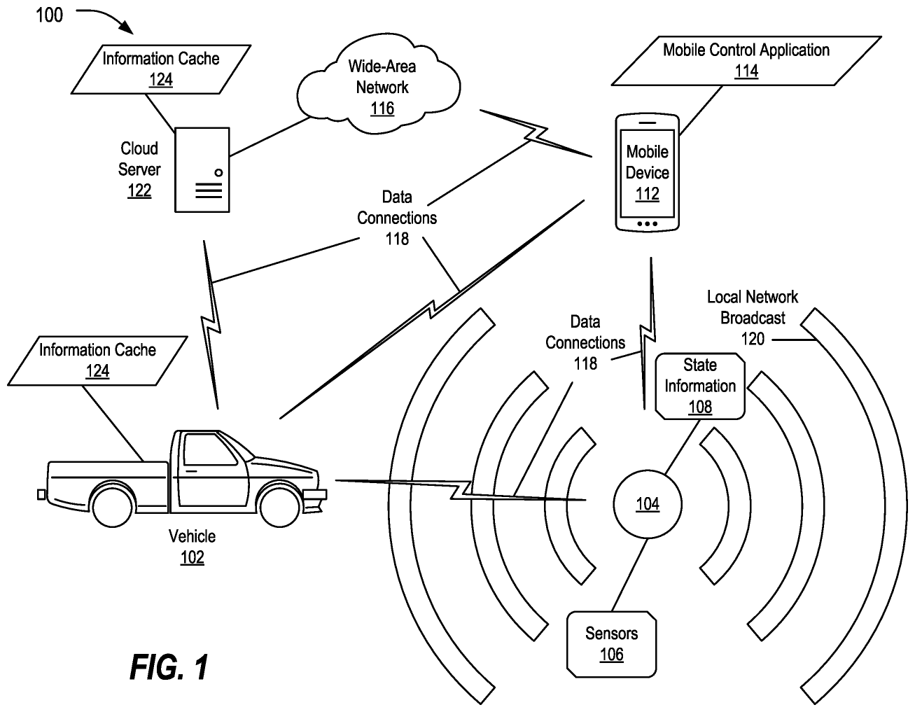

FIG. 1 illustrates an example system 100 for using a vehicle 102 as a hub implementing a unidirectional wireless communication protocol. The system 100 includes a vehicle 102 configured to provide transport and navigation and a portable device 104 configured to provide information via various sensors 106. A mobile device 112 may utilize a mobile control application 114 to keep the user informed of water-related events. A wide-area network 116 may provide connectivity to the devices of the system 100. A cloud server 122 may provide a data sink and computing services to the vehicle 102, portable device 104, and/or mobile device 112 via the wide-area network 116.

The vehicle 102 may include various types of automobile, crossover utility vehicle (CUV), sport utility vehicle (SUV), truck, recreational vehicle, boat, plane or other mobile machine for transporting people or goods. Such vehicles 102 may be human-driven or autonomous. In many cases, the vehicle 102 may be powered by an internal combustion engine. As another possibility, the vehicle 102 may be a battery electric vehicle powered by one or more electric motors. As a further possibility, the vehicle 102 may be a hybrid electric vehicle powered by both an internal combustion engine and one or more electric motors, such as a series hybrid electric vehicle, a parallel hybrid electrical vehicle, or a parallel/series hybrid electric vehicle.

The vehicle 102 may be a vehicle driven by a driver with driver assistance features. In other examples, the vehicle may be a semi-autonomous vehicle (AV). These AV or driver assistance features may be supported via received vehicle-to-everything (V2X) data. The level of automation may vary between different levels of driver assistance technology to a fully automatic, driverless vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs), e.g., as defined by International Organization for Standardization (ISO) 3779 and ISO 4030. It should be noted that while automotive vehicles 102 are being used as an example, other types of hub devices may additionally or alternately be used, such as roadside units, cellular towers, etc., which may be equipped with V2X technology.

The vehicle 102 may act as a central hub for communication with portable devices 104. The vehicle 102 may be configured to transport the portable device 104, the user, while also providing wireless connectivity to enable the user to more easily utilize the portable devices 104. The vehicle 102 may also be configured to supply energy to the portable device 104.

In one non-limiting example, the portable devices 104 may include portable water filters. In such an example, the vehicle 102 may as well as to help the user with the task of finding and collecting drinking water as well as providing wireless connectivity to enable the user to more easily collect water and ensure the reliability of the water supply. In such an example, the portable device 104 may be one of various devices configured to receive water and remove impurities from the water. This may include removing sediment, bacteria, and/or chemicals from the water. In many cases, water is passed through filter media, such as a fine physical barrier, a chemical pack, or biological media. Once filtered, the water may be retained in a container or otherwise made available for use.

In another non-limiting example, the portable devices 104 may include portable air compressors. For instance, the air compressor may be used by an operator to fill tires of the vehicle 102 or of another device. The air compressor may accordingly broadcast information such as air pressure of an air tank of the air compressor, pressure of a tire connected to the air compressor, an amount of time that the air compressor has been in operation, etc.

The portable device 104 may include various sensors 106 and instrumentation. The sensors 106 may be configured to measure various state information 108 descriptive of the operation of the portable device 104. The sensors 106 may include flow sensors, temperature sensors, pressure sensors, etc. Continuing with the example of a filter, the state information 108 may include, as some non-limiting examples: water filtered over the lifetime of the portable device 104, ambient temperature of the portable device 104, water filtered over a current filtering session of the portable device 104, gallons of water filtered by filter media installed to the portable device 104, water pressure within the portable device 104, portable device 104 operational mode and status (e.g., filtering, standby, full, empty, etc.), as some non-limiting examples. The portable device 104 may also provide a filter media life system that indicates when the filter media requires replacement, e.g., as opposed to when a timer has run out independent of usage.

The portable device 104 may also utilize the sensors 106 to identify characteristics of the environment around the portable device 104. These characteristics may be used to aid in diagnostics and troubleshooting and/or alerts. In a filtering example, this may include to provide an alert if the filter media of the portable device 104 is clogged or is no longer receiving water to be filtered. For instance, the sensors 106 may be used to indicate that the intake is no longer submerged or is clogged.

The mobile device 112 may be any of various types of portable computing device, such as cellular phones, tablet computers, smart watches, laptop computers, portable music players, key fobs, or other such devices brought into the vehicle 102 and having processing and communications capabilities. The mobile device 112 may include one or more processors configured to execute computer instructions, and a storage medium on which the computer-executable instructions and/or data may be maintained. The mobile control application 114 may be installed to the mobile device 112 to allow the mobile device 112 to interact with aspects of the portable device 104. Further aspects of the operation of the mobile control application 114 are discussed in detail herein.

The wide-area network 116 may include one or more interconnected communication networks such as the Internet, a cable television distribution network, a satellite link network, a local area network, and a telephone network, as some non-limiting examples. The wide-area network 116 may facilitate the communication of data over data connections 118 between the vehicles 102, portable devices 104, and mobile devices 112 of the system 100. These data connections 118 are shown as lightning symbols in FIG. 1.

The portable device 104 may also be configured to broadcast connectionless information over a local network broadcast 120, such as a BLE or another connectionless broadcast protocol. The local network broadcast 120 is illustrated in FIG. 1 as omnidirectional arcs. As compared to the data connections 118, the local network broadcast 120 may be received by the vehicle 102 and/or the mobile device 112 without the overhead of a paired or otherwise established data connection 118.

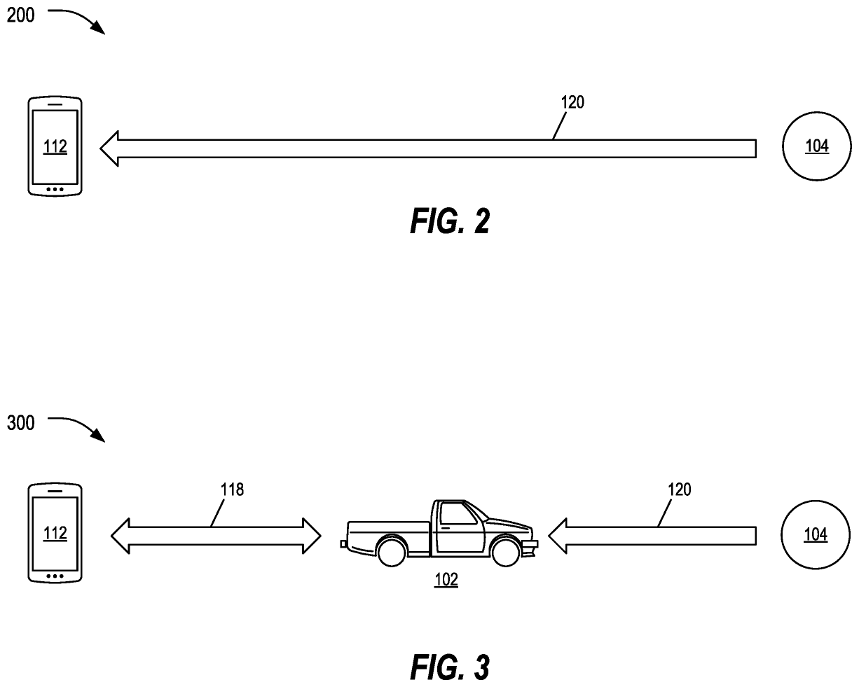

FIG. 2 illustrates an example arrangement 200 of the mobile device 112 receiving the local network broadcasts 120 from the portable device 104. As shown, the local network broadcast 120 may be received to the mobile device 112 directly, without intermediate devices. The local network broadcast 120 may include aspects of the state information 108. This may allow the mobile device 112 to receive status information from the portable device 104 without establishing and maintaining a data connection 118 to the portable device 104.

FIG. 3 illustrates an example arrangement 300 of the vehicle 102 receiving the local network broadcasts 120 from the portable device 104. As shown, the local network broadcast 120 may be received to the vehicle 102. Here again, the local network broadcast 120 may include aspects of the state information 108. Additionally, the mobile device 112 may communicate with the vehicle 102 over a data connection 118 to receive the state information 108.

The vehicle 102 may be configured to receive the state information 108 via the local network broadcasts 120. In an example, a cyclic series of BLE advertising packets, may be received by a radio of the vehicle 102, without requiring pairing with that radio. The vehicle 102 may collect and manage the lifecycle of the state information 108 received in the local network broadcasts 120.

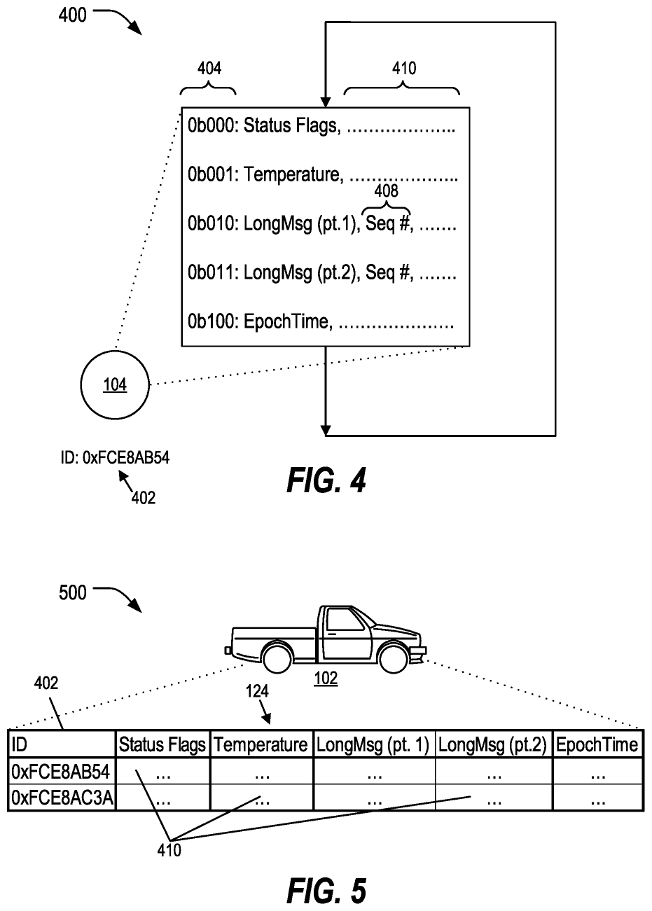

FIG. 4 illustrates an example diagram of a cyclic series 400 of local network broadcasts 120. Each packet of the local network broadcast 120 may include defined fields of information, including a device identifier 402 and a manufacturer-specific sequence 404. The manufacturer-specific sequence 404 may include three items: a field identifier 406, a sequence identifier 408, and a data element 410. As shown, the cyclic series 400 includes status flags for the portable device 104, temperature measured by the portable device 104, a long message spanning multiple field identifiers 406 (int this example two), and an epoch time indicative of the time at which the data elements 410 are sent. It should be noted that this is only one example, and more, fewer, or differently arranged fields of information may be broadcast.

The device identifier 402 may be an element that acts as an identifier for the sending device (e.g., the portable device 104), such as a serial number or device name (if unique). The device identifier 402 may indicate to the receiving device (e.g., the vehicle 102) which specific transmitter is sending the data, if there should be more than one nearby.

The field identifier 406 may be a series of bits that encodes a numeric index of the value being sent. In cases where the value being sent is larger than may fit into a single packet, a consecutive series of field identifiers 406, e.g., a sub-sequence of bits may be used to indicate following segments of the data element 410.

The sequence identifier 408 may be included in multi-packet messages. The sequence identifier 408 may have the same value for every packet in the multi-packet message and then be changed afterward. Thus, the data element 410 may only be considered received when each of the packets having the same sequence identifier 408 is received. This prevents merging of incomplete sequences of data into an incorrect value. Implementations may also apply this to all messages in the current cycle of the rotation, if the messages are intended to be received as a set.

The data element 410 may be the series of bytes that takes up the remainder of the space in the packet. The data element 410 may be of an arbitrary format and may include contents for each field identifier 406 in a format that is shared by the sender and receiver.

The transmitter may send each packet in the order of their field identifiers 406 (so, multi-packet message components arrive sequentially). The receiver may, on receiving the packet, decode the device identifier 402 to determine if the receiver wants to receive messages from this transmitter. The receiver may then index the data in the packet into memory in the information cache 124, using the field identifier 406 to indicate which data element 410 is currently being received.

The information cache 124 is cached, to protect against lost packets or poor reception. A given field is only updated to the receiver when all associated elements required for data integrity have been successfully received. A one-packet field, such as an integer, may be updated after receiving it, e.g., if there is no dependency on other fields arriving concurrently. A multiple-packet field, such as a text string, may only be updated after all of its components have been received and if they have the same sequence identifier 408, which prevents different ages of data from being merged into an incorrect value.

Referring back to FIG. 1, the vehicle 102 may maintain a information cache 124 of the state information 108 received via the cyclic series 400 of packets. The information cache 124 may, for example, include a snapshot of the most recent set of information received via a full cycle of the local network broadcast 120. The mobile device 112 may access the vehicle 102 to access the most current data in the local network broadcast 120 advertising packets stored in the information cache 124. Thus, the vehicle 102 may act as a hub for information about the portable device 104.

FIG. 5 illustrates an example 500 of the information cache 124. As shown, cached state information 108 is maintained for two example portable devices 104, including the portable device 104 shown in FIG. 4. The state information 108 is indexed by device identifier 402, for example, to allow for querying for a portable device 104 that the mobile device 112 is interested in.

The cloud server 122 may also be configured to maintain various information and services for use by the vehicles 102 and mobile devices 112. In an example, the cloud server 122 may additionally or alternately maintain information cache 124 received from the vehicle 102, e.g., over the wide-area network 116 from vehicles 102 receiving local network broadcasts 120 from the portable devices 104.

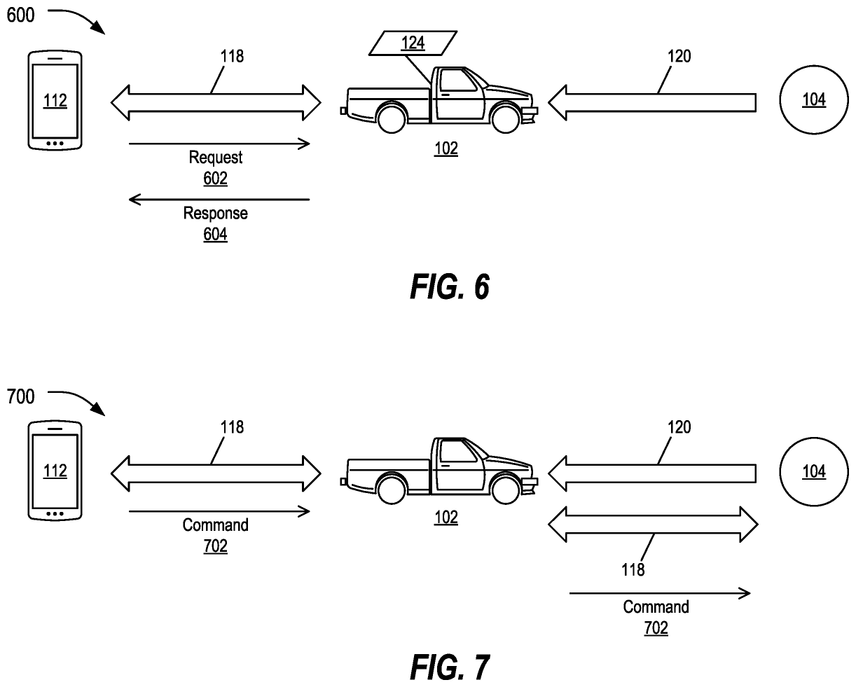

FIG. 6 illustrates an example diagram 600 of the vehicle 102 operating as a hub responding to received requests 602. As shown, the request 602 is received to the vehicle 102 over the data connection 118 between the mobile device 112 and the vehicle 102. In an example, the request 602 may specify a device identifier 402 for which the mobile device 112 desires the latest available state information 108. The vehicle 102 receiving the request 602 may access the information cache 124 to locate the state information 108 corresponding to the device identifier 402. This information may then be provided to the mobile device 112 in a response 604 to the request 602. Thus, the vehicle 102 may be able to provide information to the mobile device 112, without the vehicle 102 or the mobile device 112 maintaining a data connection 118 to the portable device 104.

FIG. 7 illustrates an example diagram 700 of the vehicle 102 operating as a hub responding to received commands 702. As with the request 602, the command 702 is received to the vehicle 102 over the data connection 118 between the mobile device 112 and the vehicle 102. In an example, the command 702 may specify a device identifier 402 that the mobile device 112 desires to command, as well as new device settings for the portable device 104. For instance, the command 702 may be sent by the mobile device 112 to turn the portable device 104 on or off.

Responsive to receipt of the command 702, the vehicle 102 may instantiate a data connection 118 with the desired portable device 104. Significantly, the local network broadcast 120 is unidirectional, so the vehicle 102 is unable to send data to the portable device 104 over the local network broadcast 120. However, once the data connection 118 with the portable device 104 is established, the vehicle 102 may forward the command 702 to the portable device 104. It should be noted that in many examples the portable device 104 may not need to send a response to the command 702. Instead, the vehicle 102 may capture the latest cyclic series 400 of local network broadcasts 120 to determine whether the command 702 was performed.

Variations on the diagram 700 are possible. In other examples, the portable device 104 may receive a connectionless command from the vehicle 102, e.g., via a local network broadcast 120 sent by the vehicle 102 without forming the data connection 118 as shown.

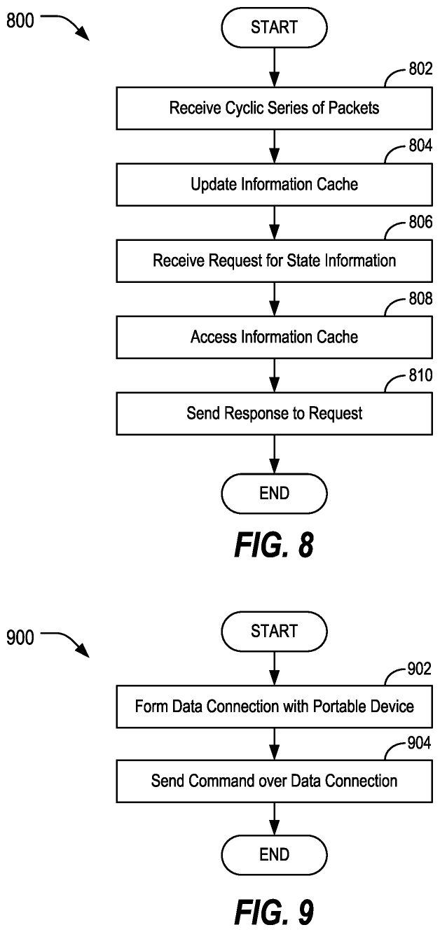

FIG. 8 illustrates an example process 800 for the use of the vehicle 102 as a hub implementing a unidirectional wireless communication protocol to maintain the information cache 124. In an example, the process 800 may be performed by the vehicle 102 in the context of the system 100.

At operation 802, the vehicle 102 receives over a local network broadcast 120 one or more packets of cyclic series 400 of state information 108. The local network broadcast 120 is sent by a portable device 104 over a connectionless broadcast protocol, where each of the plurality of packets may include a device identifier 402 of the portable device 104, a field identifier 406 of the state information 108 being sent, and a data element 410 indicative of a value of the state information 108 for the field identifier 406. The cyclic series 400 may be sent by the portable device 104 periodically, to allow the vehicle 102 to be informed of the latest state information 108 from the portable device 104, without the vehicle 102 having to form a data connection 118 with the portable device 104. An example of the cyclic series 400 is shown in FIG. 4.

At operation 804, the vehicle 102 updates the information cache 124. In an example, the vehicle 102 may, responsive to receiving packets of the cyclic series 400, may decode the device identifier 402 in each of the packets to determine if the vehicle 102 wants to receive messages from this portable device 104. The vehicle 102 may then index the data into memory in the information cache 124 for the device identifier 402, using the field identifier 406 to indicate which data element 410 is currently being received. An example of the information cache 124 is shown in FIG. 5.

In some examples, the plurality of packets includes a long message spanning multiple packets of the cyclic series 400, each of the multiple packets including a sequence identifier 408 with the same value for each of the multiple packets. In such an example, the vehicle 102 may update the state information 108 to include the data elements 410 of the long message responsive to receiving each of the multiple packets having the same sequence identifier 408.

At operation 806, the vehicle 102 receives a request 602 for state information 108. In an example, the mobile device 112 may establish a data connection 118 between the mobile device 112 and the vehicle 102. Then, the mobile device 112 may send a request 602 over the data connection 118 that specifies a device identifier 402 for which the mobile device 112 desires the latest available state information 108. The vehicle 102 may accordingly receive the request 602 over the data connection 118.

At operation 808, the vehicle 102 accesses the information cache 124. In response to the request 602 received at operation 806, the vehicle 102 may access the information cache 124 to locate the state information 108 corresponding to the device identifier 402.

At operation 810, the vehicle 102 sends a response 604 to the request 602. The response 604 may include the state information 108 retrieved from the information cache 124 and may be sent back to the mobile device 112 over the data connection 118. Thus, the vehicle 102 may be able to provide information to the mobile device 112, without the vehicle 102 or the mobile device 112 maintaining a data connection 118 to the portable device 104. After operation 810, the process 800 ends.

FIG. 9 illustrates an example process 900 for controlling the portable device 104 from the vehicle 102 operating as a hub. As with the process 800, the process 900 may be performed by the vehicle 102 in the context of the system 100.

At operation 902, the vehicle 102 receives a command 702. In an example, the mobile device 112 may establish a data connection 118 between the mobile device 112 and the vehicle 102. Or the mobile device 112 may have previously established a data connection 118 with the vehicle 102, e.g., for sending requests 602 for state information 108 and/or for sending commands 702. The command 702 may specify a device identifier 402 for which the mobile device 112 desires to interaction, as well as the specific operation to be performed by the portable device 104. In one example, the command 702 may request to toggles the status of whether or not the portable device 104 is presently filtering water. The vehicle 102 may receive the command 702 over the data connection 118.

At operation 904, the vehicle 102 sends the command 702 to the portable device 104. In an example, the vehicle 102 may instantiate a data connection 118 with the desired portable device 104. Once the data connection 118 with the portable device 104 is established, the vehicle 102 may forward the command 702 to the portable device 104. After operation 904, the process 900 ends.

Thus, the disclosed approach provides a solution that sends user-configurable data with a field identifier 406 per item of data being transmitted and a device identifier 402, which requires minimal software overhead compared to a data connection 118 based approach.

The disclosed approach is therefore easy for the customer to use, as no physical setup is required for the portable devices 104 or other devices to begin communicating. Choosing which portable devices 104 or other devices that the user desires to receive from is as simple as selecting based on the device identifier 402. This accordingly replaces a physical pairing procedure with a selection of subscribed transmitters.

The receiver (in many examples the vehicle 102 but other types of receiver may be used such as the mobile device 112) will easily work with multiple transmitters (e.g., the portable devices 104, but other types of devices may be used as well) and can be switched between any or all of them at any time.

Additionally, the disclosed approach is resistant to poor signal conditions. The packets are sent in a rolling sequence of the cyclic series 400, so if a packet is missed, the receiver only waits a short time to receive the next copy of it. No replies are needed, so it does not matter if the sender does not hear back from the receiver.

Yet further, high simultaneous communication limits are possible. Many Bluetooth LE devices can transmit simultaneously, with no limit on the number of receivers. A given receiver may choose to receive messages from one, a few, or all active transmitters at the same time.

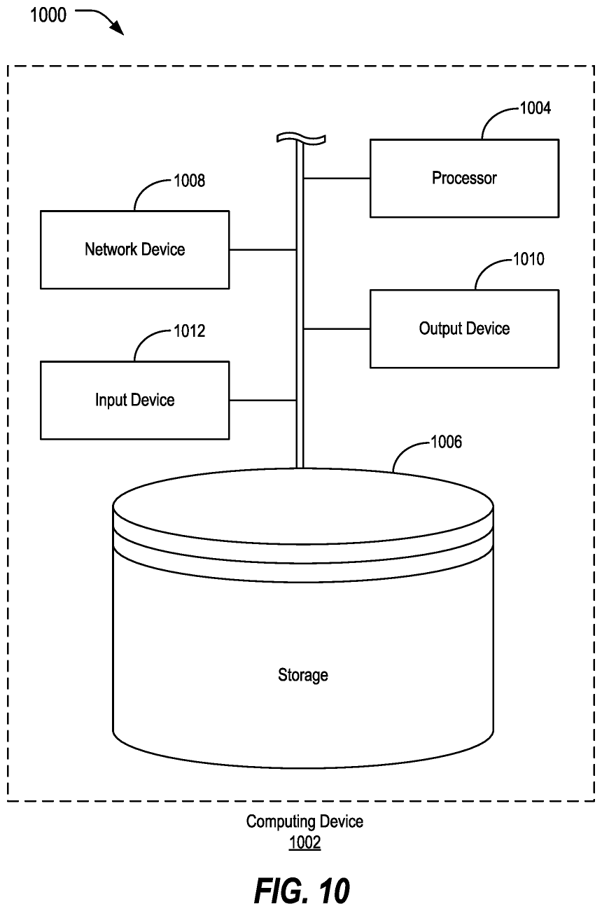

FIG. 10 illustrates an example 1000 of a computing device 1002 for use in using the vehicle 102 as a hub for using the portable devices 104. Referring to FIG. 10, and with reference to FIGS. 1-9, the vehicles 102, portable devices 104, mobile devices 112, cloud server 122, etc., may include examples of such computing devices 1002. As shown, the computing device 1002 may include a processor 1004 that is operatively connected to a storage 1006, a network device 1008, an output device 1010, and an input device 1012. It should be noted that this is merely an example, and computing devices 1002 with more, fewer, or different components may be used.

The processor 1004 may include one or more integrated circuits that implement the functionality of a central processing unit (CPU) and/or graphics processing unit (GPU). In some examples, the processors 1004 are a system on a chip (SoC) that integrates the functionality of the CPU and GPU. The SoC may optionally include other components such as, for example, the storage 1006 and the network device 1008 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 1004 executes stored program instructions that are retrieved from the storage 1006. The stored program instructions, accordingly, include software that controls the operation of the processors 1004 to perform the operations described herein, such as those of the mobile control application 114. The storage 1006 may include both non-volatile memory and volatile memory devices. The non-volatile memory includes solid-state memories, such as not and (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system 100.

The GPU may include hardware and software for display of at least two-dimensional (2D) and optionally three-dimensional (3D) graphics to the output device 1010. The output device 1010 may include a graphical or visual display device, such as an electronic display screen, projector, printer, or any other suitable device that reproduces a graphical display. As another example, the output device 1010 may include an audio device, such as a loudspeaker or headphone. As yet a further example, the output device 1010 may include a tactile device, such as a mechanically raiseable device that may, in an example, be configured to display braille or another physical output that may be touched to provide information to a user.

The input device 1012 may include any of various devices that enable the computing device 1002 to receive control input from users. Examples of suitable input devices that receive human interface inputs may include keyboards, mice, trackballs, touchscreens, voice input devices, graphics tablets, and the like.

The network devices 1008 may each include any of various devices that enable the vehicles 102, portable devices 104, mobile devices 112, and/or cloud servers 122, to send and/or receive data from external devices over networks (such as the wide-area network 116). Examples of suitable network devices 1008 include an Ethernet interface, a Wi-Fi transceiver, a cellular transceiver, a satellite transceiver, a V2X transceiver, a BLUETOOTH or BLE transceiver, or other network adapter or peripheral interconnection device that receives data from another computer or external data storage device, which can be useful for receiving large sets of data in an efficient manner.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, case of assembly, etc. As such, to the extent any embodiments are described as less desirable than other embodiments or prior art implementations with respect to one or more characteristics, these embodiments are not outside the scope of the disclosure and can be desirable for particular applications.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of using a vehicle as a communications hub for communication with portable devices, comprising:
receiving, by the vehicle, a plurality of packets of a cyclic series of state information sent over a local network broadcast from a portable device, the local network broadcast being sent over a connectionless broadcast protocol, each of the plurality of packets including a device identifier of the portable device, a field identifier of the state information being sent, and a data element indicative of a value of the state information for the field identifier;
updating an information cache to include the state information;
receiving a request for the state information from a mobile device over a data connection, the request including the device identifier; and
sending the requested state information to the mobile device as retrieved from the information cache according to the device identifier.

2. The method of claim 1, wherein the request is received from the mobile device over a wide-area network.

3. The method of claim 1, wherein the plurality of packets includes a long message spanning multiple packets of the cyclic series, each of the multiple packets including a sequence identifier with the same value for each of the multiple packets, and further comprising:
updating the information cache to include the data elements of the long message responsive to receiving each of the multiple packets having the same sequence identifier.

4. The method of claim 1, wherein one of packets of the cyclic series includes epoch time indicative of the time at which the data elements are sent.

5. The method of claim 1, wherein the packets of the cyclic series include an ambient temperature of the portable device, and status flags of the portable device including whether the portable device operating, an amount of water that is being filtered, an amount of hours the portable device has been operating, and/or filter life of the portable device.

6. The method of claim 1, further comprising:
forming a data collection between the vehicle and the portable device; and
sending a command to the portable device over the data connection.

7. The method of claim 6, wherein the portable device is a filter, one of packets of the cyclic series includes status flags of the filter, the status flags indicating whether or not the filter is presently filtering water, and wherein the command toggles the status of whether or not the filter is presently filtering water.

8. The method of claim 7, further comprising:
receiving a second plurality of packets of the cyclic series of state information sent over the local network broadcast from the filter, the second plurality of packets being received after the command is sent to the filter;
updating the information cache to include the state information from the second plurality of packets; and
determining whether the command was successful based on the second plurality of packets.

9. The method of claim 1, wherein the portable device is an air compressor, and the packets of the cyclic series include one or more of air pressure of the air compressor or tire pressure of a tire connected to the air compressor.

10. A system implementing a hub for communication with portable devices, comprising:
one or more computing devices configured to:
receive a plurality of packets of a cyclic series of state information sent over a local network broadcast from a portable device, the local network broadcast being sent over a connectionless broadcast protocol, each of the plurality of packets including a device identifier of the portable device, a field identifier of the state information being sent, and a data element indicative of a value of the state information for the field identifier;
update an information cache to include the state information;
receive a request for the state information from a mobile device over a data connection, the request including the device identifier; and
send the requested state information to the mobile device as retrieved from the information cache according to the device identifier.

11. The system of claim 10, wherein the request is received from the mobile device over a wide-area network.

12. The system of claim 10, wherein the plurality of packets includes a long message spanning multiple packets of the cyclic series, each of the multiple packets including a sequence identifier with the same value for each of the multiple packets, and further comprising:
updating the state information to include the data elements of the long message responsive to receiving each of the multiple packets having the same sequence identifier.

13. The system of claim 10, wherein one of packets of the cyclic series includes epoch time indicative of the time at which the data elements are sent.

14. The system of claim 10, wherein one of packets of the cyclic series includes an ambient temperature of the portable device, and status flags of the portable device including whether the portable device operating, an amount of water that is being filtered, an amount of hours the portable device has been operating, and/or filter life of the portable device.

15. The system of claim 10, wherein the one or more computing devices are further configured to:
form a data collection between the one or more computing devices and the portable device; and
send a command to the portable device over the data connection.

16. The system of claim 15, wherein the portable device is a filter, one of packets of the cyclic series includes status flags, the status flags indicating whether or not the filter is presently filtering water, and wherein the command toggles the status of whether or not the filter is presently filtering water.

17. The system of claim 16, wherein the one or more computing devices are further configured to:
receive a second plurality of packets of the cyclic series of filter information sent over the local network broadcast from the filter, the second plurality of packets being received after the command is sent to the filter;
update the information cache to include the filter information from the second plurality of packets; and
determine whether the command was successful based on the second plurality of packets.

18. A non-transitory computer-readable medium comprising instructions for implementing a hub for communication with portable devices that, when executed by one or more computing devices, cause the one or more computing devices to perform operations including to:
receive a plurality of packets of a cyclic series of state information sent over a local network broadcast from a portable device, the local network broadcast being sent over a connectionless broadcast protocol, each of the plurality of packets including a device identifier of the portable device, a field identifier of the state information being sent, and a data element indicative of a value of the state information for the field identifier;
update an information cache to include the state information;
receive a request for the state information from a mobile device over a data connection, the request including the device identifier; and
send the requested state information to the mobile device as retrieved from the information cache according to the device identifier.

19. The medium of claim 18, wherein the plurality of packets includes a long message spanning multiple packets of the cyclic series, each of the multiple packets including a sequence identifier with the same value for each of the multiple packets, and further comprising:
updating the state information to include the data elements of the long message responsive to receiving each of the multiple packets having the same sequence identifier.

20. The medium of claim 18, further comprising instructions that, when executed by the one or more computing devices, cause the one or more computing devices to perform operations including to:
form a data collection between the one or more computing devices and the portable device; and
send a command to the portable device over the data connection.

21. The medium of claim 20, further comprising instructions that, when executed by the one or more computing devices, cause the one or more computing devices to perform operations including to:
receive a second plurality of packets of the cyclic series of state information sent over the local network broadcast from the portable device, the second plurality of packets being received after the command is sent to the portable device;
update the information cache to include the state information from the second plurality of packets; and
determine whether the command was successful based on the second plurality of packets.
